(19) United States
(12) Patent Application Publication
(10) Pub. No.: US 2005/0196007 A1
(43) Pub. Date: Sep. 8, 2005

(54) Adhesive microphone

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/791,864

(22) Filed: Mar. 4, 2004

(51) Int. Cl. H04R 25/00

(52) U.S. Cl. 381/364; 381/375

(57) ABSTRACT

An adhesive microphone employs a membrane sound receiver to adhere to an appropriate portion of the human skin that slightly vibrates with the speaking voice. The membrane sound receiver has a first membrane layer adhered to the outer sound receiving portion of the main body, a second membrane layer adhered to a sound source to acquire a sound signal and a sound receiving layer disposed between the first and second membrane layers. The sound receiving layer has least a sound receiving hole for sound input.

### FIELD OF THE INVENTION

The present invention is directed to an adhesive microphone, and more particularly, to a microphone that has a membrane sound receiver and can be adhered to the human skin.

### BACKGROUND OF THE INVENTION

With the popularization of communication products, the input source for sound transmission becomes more important. In the present, the major input source is the “microphone”. The microphone is a necessary auxiliary tool for sound transmission. Hence, employing the microphone for communication of cellular phones, sound reception, sound recordation and so on has been extensively applied in daily life and is popular. Therefore, the structure of the microphone has become very important.

Reference is made to FIG. 1, which is a schematic diagram of a conventional microphone. The cellular phone 1 connects with an earphone 12 and a microphone 13 to perform a fully duplex voice communication. The clip 15 connected with the microphone 13 can be used to clip onto a user's clothing to bring the microphone 13 close to the sound source.

Reference is made to FIG. 2, which is a schematic diagram for using a conventional Bluetooth earphone. The Bluetooth earphone 2 employs the Bluetooth communication techniques to connect with a remote Bluetooth cellular phone. The microphone for receiving the sound (not numbered) is disposed inside the Bluetooth earphone 2. It is close to the user's sound source to acquire the sound signals.

In the above description, during in use, the conventional microphone needs to be held by hand or fixed on a holder to be close to the sound source or a user's mouth. Hence, it has many drawbacks in use. At the same time, the conventional microphone employs the air to transmit voice signals. Although it can have quite a good tone quality, its biggest drawback is that it cannot be isolated from the background noise and hence it easily produces a “echo sound”, commonly called a roar effect.

Reference is made to FIG. 3, which is a schematic diagram of another conventional microphone. It is a contact microphone used to transmit sounds indirectly, available on the market. The cellular phone 1 is connected with a earphone 12 and a contact microphone 13 to perform a fully duplex voice communication. The holder 14 is connected with the microphone 13 and used to fix the microphone 13 on user's neck. The contact microphone 13 is used to sense the vibration of human body and then transmit the sounds indirectly. It has the drawbacks that it emphasizes low-pitched voices and suppresses the middle and high-pitched voices. Hence, it will result in the distortion of the sounds, making the voice turbid, as if heard from behind a wall or robot's talking. It will make the voice difficult to understand and the identity of the speaker unrecognizable. Therefore, its tone quality isn't very good.

However, with all improvements to the microphone, background noise is still transmitted by the microphone to lower the communication quality.

Accordingly, as discussed above, the prior art still has some drawbacks that could be improved. The present invention aims to resolve the drawbacks in the prior art.

### SUMMARY OF THE INVENTION

An objective of the present invention is to provide an adhesive microphone able to employ a membrane sound receiver to adhere to an appropriate portion of the human skin that slightly vibrates with the speaking voice to acquire sound signals. Meantime, it will amplify the sound signals via the amplifying circuit.

For reaching the objective above, the present invention provides an adhesive microphone. It primarily has a membrane sound receiver disposed on a main body of the microphone. The membrane sound receiver is adhered to the main body via the first membrane layer and able to adhered to the sound source of the human skin via the second membrane layer to acquire sound signals. Further, the adhesive microphone has a sound receiving layer disposed between the first and second membrane layers. The sound receiving layer has a least a sound receiving hole for sound input.

The present invention further provides an adhesive microphone able to adhered to the sound source of the human skin via the second membrane layer to acquire sound signals. Meantime, it can also be isolated from the background noise and won't produce the annoying echo sounds. It can also improve the conventional contact microphone to remove the problem of emphasizing the low-pitched voices and suppressing the middle and high-pitched voices to distort received sounds.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional microphone;

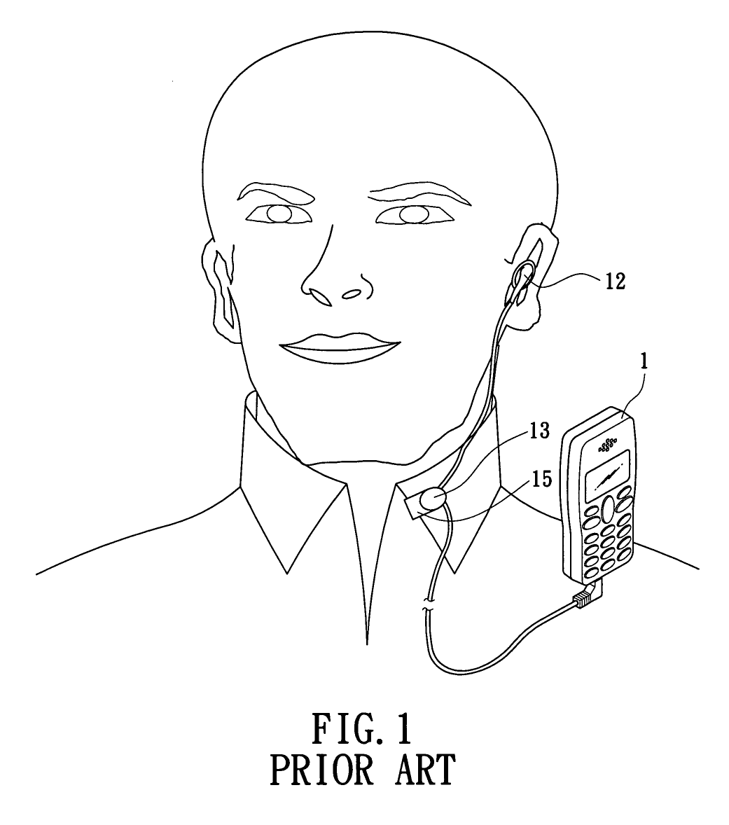

FIG. 2 is a schematic diagram for using a conventional Bluetooth earphone;

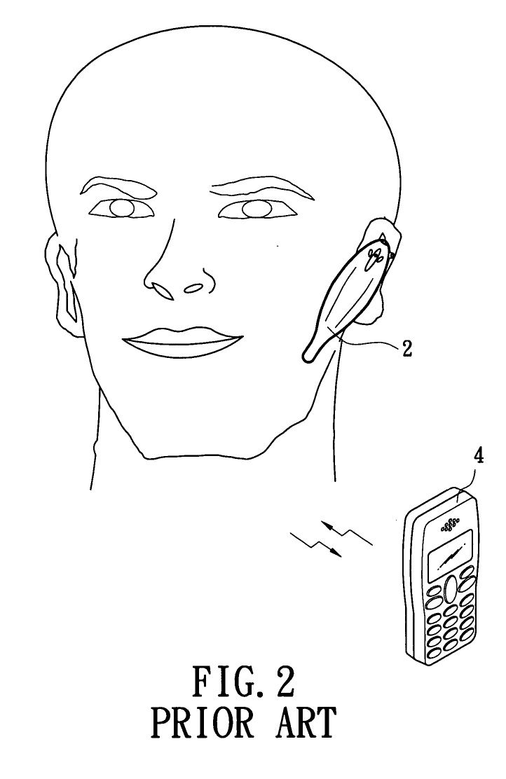

FIG. 3 is a schematic diagram of another conventional microphone;

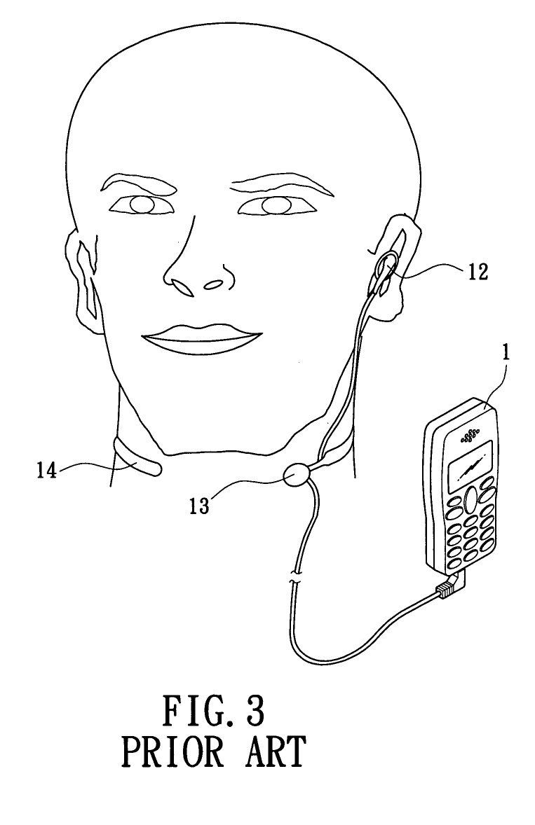

FIG. 4 is a schematic diagram of an adhesive microphone in accordance with the present invention;

FIG. 5 is a schematic diagram of the first embodiment in accordance with the present invention; and

FIG. 6 is a schematic diagram of the second embodiment in accordance with the present invention.

### DETAILED DESCRIPTION

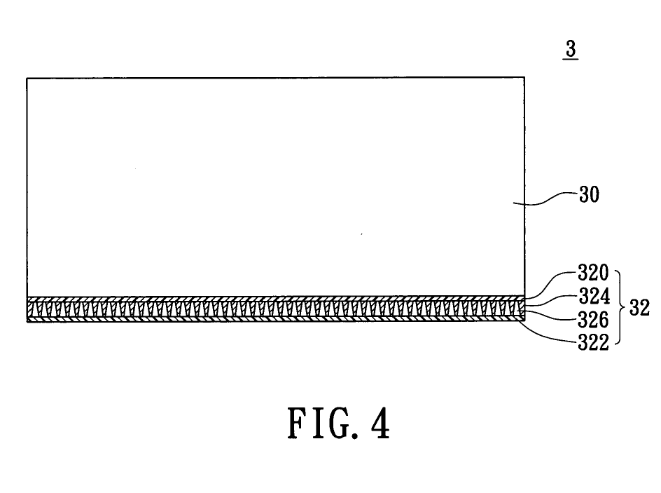

Reference is made to FIG. 4, which is a schematic diagram of an adhesive microphone in accordance with the present invention. The adhesive microphone 3 of the present invention primarily has a membrane sound receiver 32 disposed on an outer sound receiving portion of the main body 30. The membrane sound receiver 32 includes a first membrane layer 320, a second membrane layer 322, and a sound receiving layer 324. In the above description, the sound receiving layer 324 has at least a sound receiving hole 326 for sound input.

Reference is also made to FIG. 4. The membrane sound receiver 32 employs the first membrane layer 320 to adhere to a sound source on the human skin for acquiring sound signals. In the above description, the sound source is the neck, cheek or bosom of the human body, which are able to slightly vibrate with the speaking voice.

Furthermore, the sound receiving layer 324 is disposed between the first member layer 320 and the second membrane layer 322. It has at least a sound receiving hole 326 for inputting sounds. The sound receiving layer 324 can be adhered to an appropriate portion of the human skin, which can slightly vibrate with the speaking voice, via the second membrane layer 322 without any gap. Hence, it can be isolated from background noise and will not produce the annoying echo sounds. In the above description, the membrane sound receiver 32 is a diathermy adhesive plate or a ventilative adhesive plate, which is adhesive on both sides.

Meanwhile, sound receiving holes 326 can be used to completely receive the sound signals produced by the slight vibration of the human body. Hence, it can resolve the problem of the conventional contact microphone, the emphasis of the low-pitched voices and suppression of the middle and high-pitched voices to distort the sounds.

Reference is still made to FIG. 4. The membrane sound receiver 32 can receive the sound signals produced by the slight vibration of the human body during speaking via the sound receiving holes 326. Meanwhile, since the membrane sound receiver 32 is adhered to the main body 30 by the first membrane layer 320, the member sound receiver 32 can transfer the sound signals from the sound receiving holes 326 to a microphone module inside the main body 30. The microphone module connects with a amplifying circuit to amplify and output the received sound signals. In the above description, the microphone module is a condenser microphone, piezoelectric microphone, piezo-sound microphone or membrane vibrating microphone.

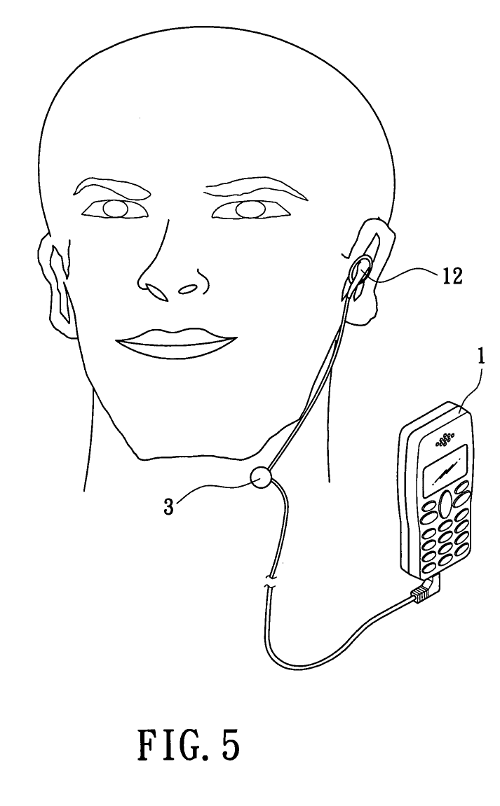

Reference is made to FIG. 4 together with FIG. 5, which is a schematic diagram of the first embodiment complied with the present invention. As shown in FIG. 5, the adhesive microphone 3 of the present invention is connected with the earphone 12 and the cellular phone 1 and adhered to a portion of the skin of user's neck. When the user speaks, the skin portion will produce sound signals due to the vibration of the throat. The sound singles will be sent to the microphone module via the membrane sound receiver 32. After processing by the amplifying circuit, the sound signals will be sent to the cellular phone 1 and then sent to the receiving person by the cellular phone 1.

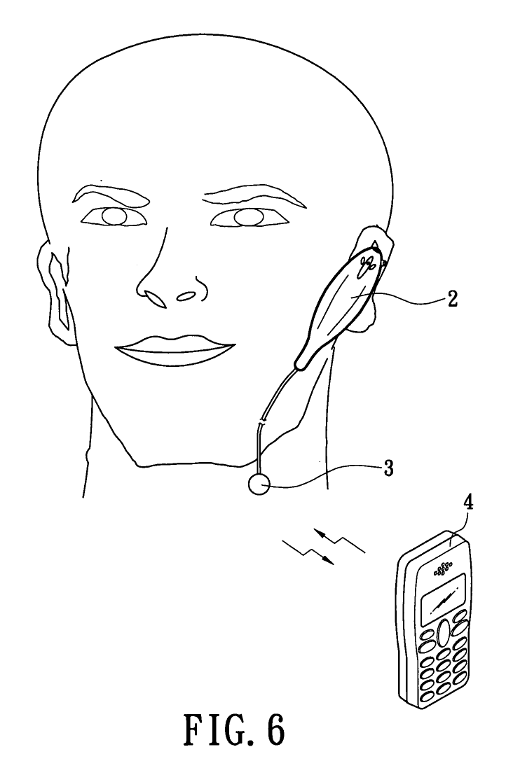

Reference is made to FIG. 4 together with FIG. 6, which is a schematic diagram of the second embodiment complied with the present invention. As shown in FIG. 6, the adhesive microphone 3 of the present invention is connected with the Bluetooth earphone 2. The sound signals acquired by the adhesive microphone 3 of the present invention from the human body will be sent to the Bluetooth earphone 2 and then sent to a remote Bluetooth cellular phone 4 via the Bluetooth earphone 2 in a wireless manner. Finally, the sound signals will be sent to a receiving person via the Bluetooth cellular phone 4. In the above description, the operation and principle of the adhesive microphone 3 of the present invention are the same as disclosed in FIG. 5.

Summing up, the present invention provides an adhesive microphone able to be adhered to a sound source of the human skin to acquire primary sound signals. Meantime, it can be completely isolated from the background noise and will not produce annoying echo sounds. Hence, the present invention can improve the conventional contact microphone to remove the problem that it emphasizes the low-pitched voices and suppresses the middle and high-pitched voices to distort received sounds.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. An adhesive microphone, adhered to a portion of human skin, the portion of human skin slightly vibrating with a speaking voice, and primarily having a membrane sound receiver disposed on an outer sound receiving portion of a main body, the membrane sound receiver comprising:
a first membrane layer adhered to the outer sound receiving portion of the main body;
a second membrane layer adhered to a sound source to acquire a sound signal; and
a sound receiving layer disposed between the first and second membrane layers, the sound receiving layer having at least a sound receiving hole for sound input.

2. The microphone as claimed in claim 1, further comprising a condenser microphone connected with a amplifying circuit disposed inside the main body, the condenser microphone used to receive the sound signal and amplifying and outputting the sound signal via the amplifying circuit.

3. The microphone as claimed in claim 1, further comprising a piezoelectric microphone connected with a amplifying circuit disposed inside the main body, the piezoelectric microphone used to receive the sound signal and amplifying and outputting the sound signal via the amplifying circuit.

4. The microphone as claimed in claim 1, further comprising a piezo-sound microphone connected with a amplifying circuit disposed inside the main body, the piezo-sound microphone used to receive the sound signal and amplifying and outputting the sound signal via the amplifying circuit.

5. The microphone as claimed in claim 1, further comprising a membrane vibrating microphone connected with a amplifying circuit disposed inside the main body, the membrane vibrating microphone used to receive the sound signal and amplifying and outputting the sound signal via the amplifying circuit.

6. The microphone as claimed in claim 1, wherein the sound source is a neck, a cheek or a bosom of the human skin and slightly vibrates with the speaking voice.

7. An adhesive microphone, adhered to a portion of human skin, the portion of human skin slightly vibrating with a speaking voice, primarily comprising a membrane sound receiver disposed on an outer sound receiving portion of a main body.

8. The microphone as claimed in claim 7, wherein the membrane sound receiver is a diathermy adhesive plate.

9. The microphone as claimed in claim 7, wherein the membrane sound receiver is a ventilative adhesive plate.

10. The microphone as claimed in claim 7, further comprising a condenser microphone connected with a amplifying circuit disposed inside the main body, the condenser microphone used to receive the sound signal and amplifying and outputting the sound signal via the amplifying circuit.

11. The microphone as claimed in claim 7, further comprising a piezoelectric microphone connected with a amplifying circuit disposed inside the main body, the piezoelectric microphone used to receive the sound signal and amplifying and outputting the sound signal via the amplifying circuit.

12. The microphone as claimed in claim 7, further comprising a piezo-sound microphone connected with a amplifying circuit disposed inside the main body, the piezo-sound microphone used to receive the sound signal and amplifying and outputting the sound signal via the amplifying circuit.

13. The microphone as claimed in claim 7, further comprising a membrane vibrating microphone connected with a amplifying circuit disposed inside the main body, the membrane vibrating microphone used to receive the sound signal and amplifying and outputting the sound signal via the amplifying circuit.
